(19) United States
(12) Patent Application Publication
(10) Pub. No.: US 2008/0007803 A1
(43) Pub. Date: Jan. 10, 2008

(54) SCANNER AND RELATED LIGHT SOURCE APPARATUS

(76) Inventors: Meng-Yun Ying, Taipei City (TW); Chung-Kai Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/551,725

(22) Filed: Oct. 23, 2006

(30) Foreign Application Priority Data
Jul. 7, 2006 (TW) 095124759

(51) Int. Cl. H04N 1/04

(52) U.S. Cl. 358/505; 358/474

(57) ABSTRACT

The invention discloses a light source apparatus. The light source apparatus includes a cold cathode fluorescent lamp (CCFL), a light emitting diode (LED) module, a light detector, a servo control module, an LED-driving module, and a CCFL driving module. The light detector detects light generated by the CCFL and the LED module to generate a detection signal. The servo control module generates a first and a second control signal according to the detection signal. The LED-driving module drives the LED module according to the first control signal. The CCFL driving module drives the CCFL according to the second control signal.

### BACKGROUND OF THE INVENTION

1. Field of the Invention

The present invention relates to scanners, and more particularly, to a scanner having a reduced warm-up time and a related light source apparatus.

2. Description of the Prior Art

Scanners are a kind of electronic device frequently used in homes and offices. In the prior art, a Cold Cathode Fluorescent Lamp (CCFL) is used as a light source apparatus of a scanner. However, the intensity of light generated by the CCFL is inevitably affected by its temperature. When the scanner is initially turned on, the temperature of the CCFL is relatively low so that it cannot generate light having enough intensity for scanning. Only after a warming period is passed can the CCFL provide light having enough intensity for scanning. The warming period, which normally lasts for several seconds, prolongs the waiting time of users therefore causing them some inconvenience.

### SUMMARY OF THE INVENTION

The claimed invention provides a scanner which comprises: a cold cathode fluorescent lamp (CCFL); a light emitting diode (LED) module; a light-detecting module, for detecting light reflecting from/penetrating through a target object that is illuminated by the CCFL and the LED module to generate a detection output signal; a gain amplifier, coupled to the light-detecting module, for amplifying the detection output signal to generate an amplified signal; a signal-processing module, coupled to the gain amplifier, for processing the amplified signal to obtain an image of the target object; a light detector, for detecting light generated by the CCFL and the LED module to generate a detection signal; a servo control module, coupled to the light detector, for generating a first control signal according to the detection signal; an LED-driving module, coupled to the servo control module and the LED module, for driving the LED module according to the first control signal; and a CCFL driving module, coupled to the CCFL module, for driving the CCFL.

The claimed invention also provides a scanner, which comprises: a cold cathode fluorescent lamp (CCFL); a light emitting diode (LED) module; a light-detecting module, for detecting light reflecting from/penetrating through a target object that is illuminated by the CCFL and the LED module to generate a detection output signal; a gain amplifier, coupled to the light-detecting module, for amplifying the detection output signal to generate an amplified signal; a signal-processing module, coupled to the gain amplifier, for processing the amplified signal to obtain an image of the target object; a servo control module, coupled to the light-detecting module, for generating a first control signal according to the detection output signal; an LED-driving module, coupled to the servo control module and the LED module, for driving the LED module according to the first control signal; and a CCFL driving module, coupled to the CCFL module, for driving the CCFL.

The claimed invention also provides a light source apparatus, which comprises: a cold cathode fluorescent lamp (CCFL); a light emitting diode (LED) module; a light detector, for detecting light generated by the CCFL and the LED module to generate a detection signal; a servo control module, coupled to the light detector, for generating a first control signal according to the detection signal; an LED-driving module, coupled to the servo control module and the LED module, for driving the LED module according to the first control signal; and a CCFL driving module, coupled to the CCFL module, for driving the CCFL.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 3 show two scanners according to two embodiments of the present invention respectively.

FIG. 2 shows an exemplary diagram illustrating how the light intensity of the light source apparatuses of FIG. 1 and FIG. 3 varies with respect to time.

### DETAILED DESCRIPTION

To solve the aforementioned problem faced by the scanners of the related art, embodiments of the present invention utilize a Light Emitting Diode (LED) to assist a CCFL to provide light that is required when a scanning task is performed by a scanner.

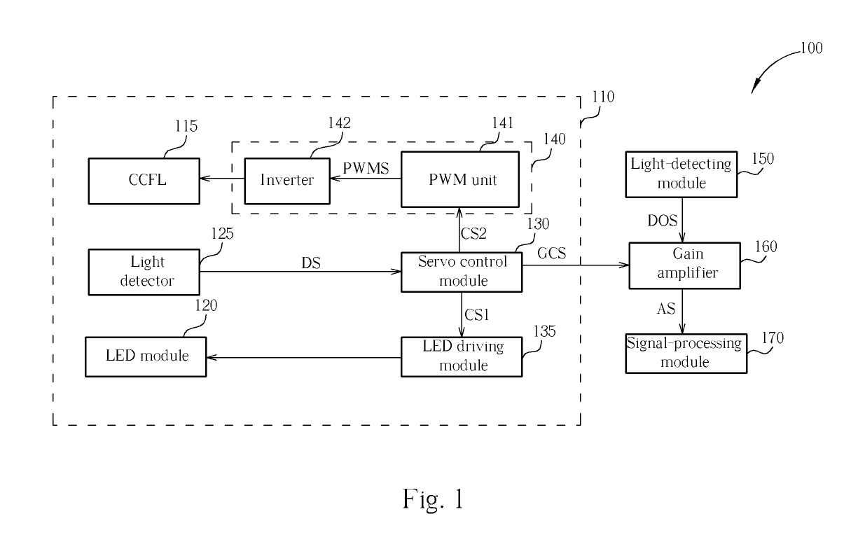

FIG. 1 shows a scanner according to an embodiment of the present invention. The scanner 100 of this embodiment comprises a light source apparatus 110, a light-detecting module 150, a gain amplifier 160, and a signal-processing module 170. The light source apparatus 110 illuminates a target object when the scanner 100 is utilized to scan an image of the target object. The light-detecting module 150 detects light reflected from/penetrated through the target object to generate a detection output signal DOS. The gain amplifier 160 amplifies the detection output signal DOS according to a gain control signal GCS so as to generate an amplified signal AS. The signal-processing module 170 may comprise analog-to-digital converters and other signal-processing components that allow the signal-processing module 170 to process the amplified signal AS to obtain an image of the target object.

In this embodiment, the light source apparatus 110 is made up of a CCFL 115, an LED module 120, a light detector 125, a servo control module 130, a LED-driving module 135, and a CCFL driving module 140. The light detector 125 detects the light generated by the CCFL 115 and the LED module 120 to generate a detection signal DS. The servo control module 130 generates a first control signal CS1, a second control signal CS2, and a gain control signal GCS according to the detection signal DS. The LED-driving module 135 drives the LED module 135 according to the first control signal CS1. The CCFL driving module 140 comprises a Pulse Width Modulation (PWM) unit 141 and an inverter 142. The PWM unit 141 generates a PWM signal PWMS according to the second control signal CS2; and the inverter 142 drives the CCFL 115 according to the PWM signal PWMS.

The light source apparatus 110 of this embodiment utilizes the CCFL 115 and the LED module 120 as a primary light source and an auxiliary light source respectively. When the scanner 100 starts a scanning task, the servo control module 130 utilizes the first control signal CS1 to control the LED-driving module 135 to drive the LED module 120. The servo control module 130 also utilizes the second control signal CS2 to control the CCFL driving module 140 to drive the CCFL 115. As mentioned, the CCFL 115 cannot instantly provide light having enough intensity for scanning. However, the LED module can be swiftly turned on and hence can provide light that compensates for the insufficient light provided by the CCFL 115. Therefore, the light instantly provided by the light source apparatus 110 will be intense enough for the scanner 100 to carry on a scanning task. In other words, the light source apparatus 110 of this embodiment can provide enough light required by the scanning task instantly. Furthermore, since the LED module 120 merely serves as an auxiliary light source, it does not have to include too many LEDs. For example, the LED module 120 may include eight LEDs or less. Compared with an LED array that can provide enough light required by a scanning task on its own, the LED module 120 of this embodiment includes fewer LEDs, where a conventional LED array normally includes sixteen LEDs or more. The cost of the LED module 120 of this embodiment is lower than that of the LED array utilized in the prior art.

After the CCFL 115 is turned on, its temperature will increase gradually, as does the intensity of the light generated by the CCFL 115. The light detector 125 will detect that the light generated by the CCFL 115 and the LED 120 is gradually strengthened. The light detector 125 then informs the servo control module 130 of its detection result; and the servo control module 130 utilizes the first control signal CS1 to control the LED-driving module 135 to lower a driving power provided to the LED module 120. In other words, while the light generated by the CCFL 115 is increasing, the servo control module 130 gradually adjusts down the light of the LED module 120. After the CCFL 115 is fully started up, the servo control module 130 can even turn the LED module 120 off completely. The light required by the scanner 100 is then provided by the CCFL 115 alone.

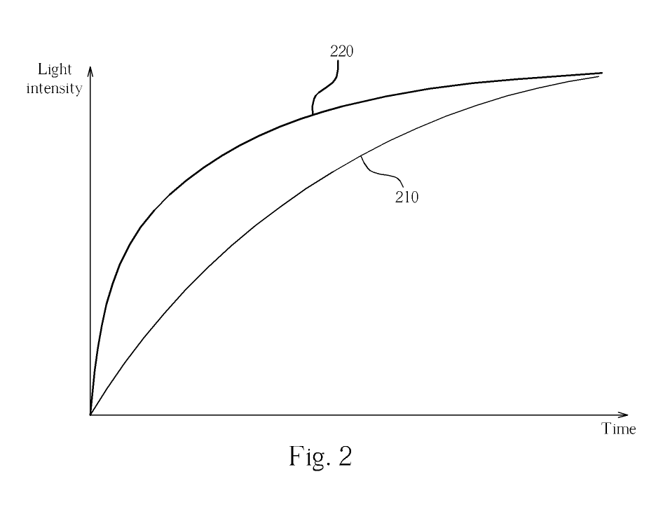

FIG. 2 shows a diagram illustrating how the light intensity of the light source apparatus 110 changes with time. A light intensity curve 210 represents the light provided by the CCFL 115 alone; another light intensity curve 220 represents the light provided by the CCFL 115 and the LED module 120 as a whole. The light intensity curve 210 can also be thought of as the light provided by a light source apparatus of the prior art, which comprises only a CCFL and does not include an LED module. With the light source apparatus of the prior art, users have to wait for fifteen to twenty seconds for the CCFL to be fully started up. Then the users can start performing scanning tasks. Since the light source apparatus 110 of this embodiment comprises not only the CCFL 115 but also the LED module 120, the light source apparatus 110 can provide light with enough intensity promptly after it is turned on. More specifically, users of the scanner 100 have to wait for only two to five seconds for the light source apparatus 110 to provide light with enough intensity for scanning. In other words, the light source apparatus 110 of this embodiment has a shorter warm up time and therefore greatly reduces the time users have to wait.

Aside from generating the first control signal CS1 and the second control signal CS2 according to the detection signal DS, the servo control module 130 of this embodiment further generates a gain control signal GCS according to the detection signal DS. When the detection signal DS reveals that the light intensity detected by the light detector 125 is low, the servo control module 130 utilizes a gain control signal GCS to control the gain amplifier 160 to amplify the detection output signal DOS with a larger gain value. On the other hand, when the detection signal DS reveals that the light intensity detected by the light detector 125 is high, the servo control module 130 utilizes the gain control signal GCS to control the gain amplifier 160 to amplify the detection output signal DOS with a smaller gain value. Therefore, with the servo control module 130, the scanning quality of the scanner 100 will not be affected by the light intensity changes of the light source apparatus 110.

Certainly, the light source apparatus 110 of this embodiment can be applied not only in scanners, but also in other electronic devices requiring integrated light sources. The electronic devices include liquid crystal displays (LCD), multi-function printers, etc.

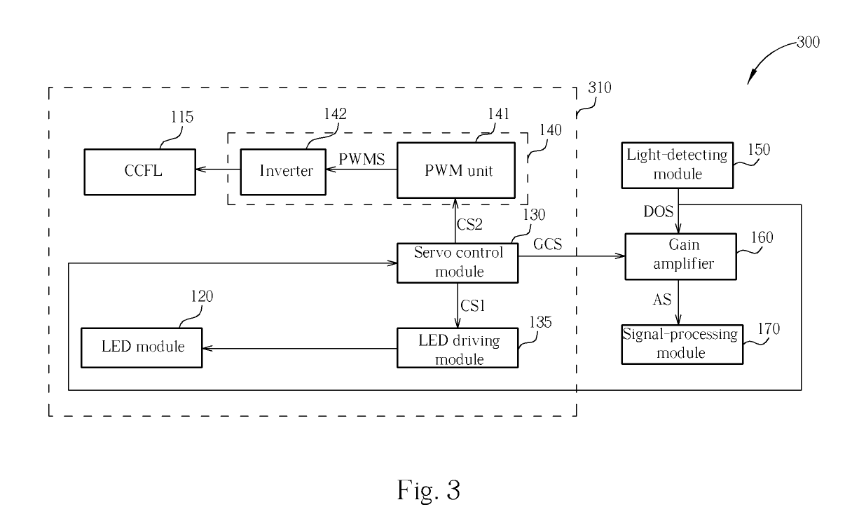

FIG. 3 shows a scanner according to another embodiment of the present invention. The architecture of the scanner 300 shown in FIG. 3 is similar to that of the scanner 100 shown in FIG. 1 . A different point between the two scanners is that the servo control module 130 of the scanner 300 functions according to the detection output signal DOS provided by the light-detecting module 150 instead of according to the detection signal DS provided by the light detector 125. Furthermore, the servo control module 130 of the scanner 300 generates the first control signal CS1, the second control signal CS2, and the gain control signal GCS according to the detection output signal DOS provided by the light-detecting module 150 instead of according to the detection signal DS provided by the light detector 125. Since the light detector 125 is excluded, the overall cost of the scanner 300 will be lower than that of the scanner 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scanner comprising:
a cold cathode fluorescent lamp (CCFL);
a light emitting diode (LED) module;
a light-detecting module, for detecting light reflecting from/penetrating through a target object that is illuminated by the CCFL and the LED module to generate a detection output signal;
a gain amplifier, coupled to the light-detecting module, for amplifying the detection output signal to generate an amplified signal;
a signal-processing module, coupled to the gain amplifier, for processing the amplified signal to obtain an image of the target object;
a light detector, for detecting light generated by the CCFL and the LED module to generate a detection signal;
a servo control module, coupled to the light detector, for generating a first control signal according to the detection signal;
an LED-driving module, coupled to the servo control module and the LED module, for driving the LED module according to the first control signal; and
a CCFL driving module, coupled to the CCFL module, for driving the CCFL.

2. The scanner of claim 1, wherein when the detection signal reveals that the light generated by the CCFL and the LED module is strengthened, the servo control module utilizes the first control signal to control the LED-driving module to decrease a driving power provided to the LED module.

3. The scanner of claim 1, wherein the servo control module further generates a second control signal according to the detection signal, and the CCFL driving module is further coupled to the servo control module and drives the CCFL according to the second control signal.

4. The scanner of claim 3, wherein the CCFL driving module comprises:
a pulse width modulation (PWM) unit, coupled to the servo control module, for generating a PWM signal according to the second control signal; and
an inverter, coupled to the PWM unit and the CCFL, for driving the CCFL according to the PWM signal.

5. The scanner of claim 1, wherein the servo control module further generates a gain control signal according to the detection signal, and the gain amplifier is further coupled to the servo control module and amplifies the detection output signal according to the gain control signal.

6. The scanner of claim 5, wherein when the detection signal reveals that the light generated by the CCFL and the LED module is strengthened, the servo control module utilizes the gain control signal to control the gain amplifier to amplify the detection output signal with a smaller gain value.

7. A scanner comprising:
a cold cathode fluorescent lamp (CCFL);
a light emitting diode (LED) module;
a light-detecting module, for detecting light reflecting from/penetrating through a target object that is illuminated by the CCFL and the LED module to generate a detection output signal;
a gain amplifier, coupled to the light-detecting module, for amplifying the detection output signal to generate an amplified signal;
a signal-processing module, coupled to the gain amplifier, for processing the amplified signal to obtain an image of the target object;
a servo control module, coupled to the light-detecting module, for generating a first control signal according to the detection output signal;
an LED-driving module, coupled to the servo control module and the LED module, for driving the LED module according to the first control signal; and
a CCFL driving module, coupled to the CCFL module, for driving the CCFL.

8. The scanner of claim 7, wherein when the detection output signal reveals that the light generated by the CCFL and the LED module is strengthened, the servo control module utilizes the first control signal to control the LED-driving module to decrease a driving power provided to the LED module.

9. The scanner of claim 7, wherein the servo control module further generates a second control signal according to the detection output signal, and the CCFL driving module is further coupled to the servo control module and drives the CCFL according to the second control signal.

10. The scanner of claim 9, wherein the CCFL driving module comprises:
a pulse width modulation (PWM) unit, coupled to the servo control module, for generating a PWM signal according to the second control signal; and
an inverter, coupled to the PWM unit and the CCFL, for driving the CCFL according to the PWM signal.

11. The scanner of claim 7, wherein the servo control module further generates a gain control signal according to the detection output signal, and the gain amplifier is further coupled to the servo control module and amplifies the detection output signal according to the gain control signal.

12. The scanner of claim 11, wherein when the detection output signal reveals that the light generated by the CCFL and the LED module is strengthened, the servo control module utilizes the gain control signal to control the gain amplifier to amplify the detection output signal with a smaller gain value.

13. A light source apparatus comprising:
a cold cathode fluorescent lamp (CCFL);
a light emitting diode (LED) module;
a light detector, for detecting light generated by the CCFL and the LED module to generate a detection signal;
a servo control module, coupled to the light detector, for generating a first control signal according to the detection signal;
an LED-driving module, coupled to the servo control module and the LED module, for driving the LED module according to the first control signal; and
a CCFL driving module, coupled to the CCFL module, for driving the CCFL.

14. The light source apparatus of claim 13, wherein when the detection signal reveals that the light generated by the CCFL and the LED module is strengthened, the servo control module utilizes the first control signal to control the LED-driving module to decrease a driving power provided to the LED module.

15. The light source apparatus of claim 13, wherein the servo control module further generates a second control signal according to the detection signal, and the CCFL driving module is further coupled to the servo control module and drives the CCFL according to the second control signal.

16. The light source apparatus of claim 15, wherein the CCFL driving module comprises:
a pulse width modulation (PWM) unit, coupled to the servo control module, for generating a PWM signal according to the second control signal; and
an inverter, coupled to the PWM unit and the CCFL, for driving the CCFL according to the PWM signal.
